(19) United States
(12) Patent Application Publication
(10) Pub. No.: US 2016/0204513 A1
(43) Pub. Date: Jul. 14, 2016

(54) BROADBAND PLANAR ANTENNA

(71) Applicant: 3M INNOVATIVE PROPERTIES COMPANY, Saint Paul, MN (US)

(72) Inventors: Constand E. Yemelong, Austin, TX (US); Karl E. Wolf, Round Rock, TX (US)

(21) Appl. No.: 14/898,356

(22) PCT Filed: Jul. 7, 2014
(86) PCT No.: PCT/US2014/045585

§ 371 Date: Dec. 14, 2015

Related U.S. Application Data
(60) Provisional application No. 61/846,840, filed on Jul. 16, 2013.

(51) Int. Cl. H01Q 9/40; H01Q 1/24; H01Q 21/28; H01Q 1/00

(52) U.S. Cl. CPC H01Q 9/40; H01Q 1/007; H01Q 1/241; H01Q 21/28

(57) ABSTRACT

A broadband antenna includes a uniplanar structure having a plurality of separate and contiguous metallic elements. A first element comprises a substantially circular metallic element having a flattened portion. A second element comprises a substantially linear metallic strip connected to an edge of the first element. The antenna further includes a pair of substantially rectangular side elements disposed on opposite sides of the second element that are electrically isolated from the first and second elements. The antenna can achieve a return loss better than 10 dB over a broadband range.

### BACKGROUND OF THE INVENTION

1. Field of the Invention

The present invention is directed to an antenna for wireless communications systems. More particularly, the antenna has an omni-directional pattern over a broad range of frequencies.

2. Background

Several hundred million multiple dwelling units (MDUs) exist globally, which are inhabited by about one third of the world's population. Better wireless communication coverage is needed to provide the desired bandwidth to an increasing number of customers. Thus, in addition to new deployments of traditional, large “macro” cell sites, there is a need to expand the number of “micro” cell sites (sites within structures, such as office buildings, schools, hospitals, and residential units). In-Building Wireless (IBW) Distributed Antenna Systems (DASs) are utilized to improve wireless coverage within buildings and related structures. Conventional DASs use strategically placed antennas or leaky coaxial cable (leaky coax) throughout a building to accommodate radio frequency (RF) signals in the 400 MHz to 6 GHz frequency range.

In recent years, consumers have demanded high rates from mobiles devices. Emerging high speed cellular and wireless technologies such as 3G, WiMax, WiFi, and LTE have promised and are delivering mobile broadband wireless connectivity. As a result, consumers are substituting landlines for mobile phones, and are expecting uninterrupted coverage from the wireless services providers. Since more than half of all mobile communications now originate from inside building, the way wireless services providers plan their networks for coverage and capacity is rapidly changing. The increase in data rate with finite transmit power will lead to cells with smaller radii. This trend will lead to a rapid development and deployment of Distributed Antenna Systems (DAS), both indoors and outdoors.

A large part of the deployment cost for an indoor DAS for an IBW system is the labor to install and upgrade the wireless cabling and hardware. Thus, a need exists for a low cost and easy to install and upgrade structured cabling transmission system. Located below the ceiling, the structured cabling system will distribute wired (via an enterprise grade Passive Optical Network (PON)) and wireless signals (Cellular, PCS, Telemetry, WiFi, Public Safety). One such system is described in co-pending US Publication Nos. 2012-0293390 and 2012-0295486. Key components of this structured cabling system include broadband antennas that are easily attached to the structured cabling solution; either directly to the cable or to the remote radio unit. Current IBW DAS deployment employs multiple discrete antennas whereby one antenna is used for each service: one antenna for Public Safety, one antenna for WiFi, and so on.

Physical and aesthetic challenges exist in providing IBW cabling for different wireless network architectures, especially in older buildings and structures. These challenges include gaining building access, limited distribution space in riser closets, and space for cable routing and management.

Outside the United States, carriers are required by law in some countries to extend wireless coverage inside buildings. In the United States, bandwidth demands and safety concerns will drive IBW applications, particularly as the world moves to current 4G architectures and beyond.

### SUMMARY

According to an exemplary aspect of the present invention, a broadband antenna includes a uniplanar structure having a plurality of separate and contiguous metallic elements. A first element comprises a substantially circular metallic element having a flattened portion. A second element comprises a substantially linear metallic strip connected to an edge of the first element. The antenna further includes a pair of substantially rectangular side elements disposed on opposite sides of the second element that are electrically isolated from the first and second elements.

In another aspect, the antenna has a bandwidth extending from about 400 MHz to about 6 GHz.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 is a front view of an antenna according to a first aspect of the invention.

FIG. 2 is a detailed view of a portion of the antenna of FIG. 1.

FIG. 3A is a view of the antenna mounted in a housing according to an aspect of the invention.

FIG. 3B is a close-up view of the coupling area of the antenna of FIG. 3A.

FIG. 4A is a top view of another antenna according to another aspect of the invention.

FIG. 4B is a plot showing simulated cross-coupling parameters of a two antennae MIMO implementation.

FIG. 5A is a front view of another antenna according to another aspect of the invention.

FIG. 5B is a front view of another antenna according to yet another aspect of the invention.

FIG. 6 is a VSWR measurement of the antenna of FIG. 1.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a planar antenna for use in a wireless communications system. In particular, the antenna is uniplanar and can provide an omni-directional pattern over a broad range of frequencies. The antenna has a low profile and can be housed in a housing that is adhesively or otherwise attached to a wall, ceiling, or utility pole. The antenna can be low cost and light weight. Housings can include multiple antennas to provide polarization diversity.

As explained herein, in one aspect, the antenna can be part of an adhesive backed wireless transceiver mounted to a wall or a ceiling tile in a structured cabling distribution system for in-building wireless (IBW) or hybrid network applications. For example, the antenna(s) described herein can provide a single broadband antenna that can support all existing wireless services where coverage and capacity is required within a building. In some aspects, a single antenna can be used for multiple communications networks (e.g., public safety, cellular carriers, and Wi-Fi), whereas in other aspects, one antenna can be used for one service, and another antenna can be used for a different service. In this context, a broadband antenna can have a bandwidth extending from 400 MHz to 6 GHz, which, for example, can provide for public safety communications as well as cellular communications.

As explained further below, the antenna can utilize a coaxial cable to attach to the communications system. The antenna(s) described herein can be mounted at many different locations in a building, such as a ceiling location or a wall location. The communications system or network described herein can be implemented as a combined network solution to provide wired in-building telecommunications. In one aspect, the network can be a modular system which includes a variety of nodes which are interconnected by a ducted horizontal cabling. Alternatively, the antenna may be used in a network that only provides for wireless communications. While the described embodiments mainly involve IBW and hybrid systems, the antenna(s) described herein can be utilized in outdoor applications as well, as would be apparent to one of ordinary skill in the art given the present description.

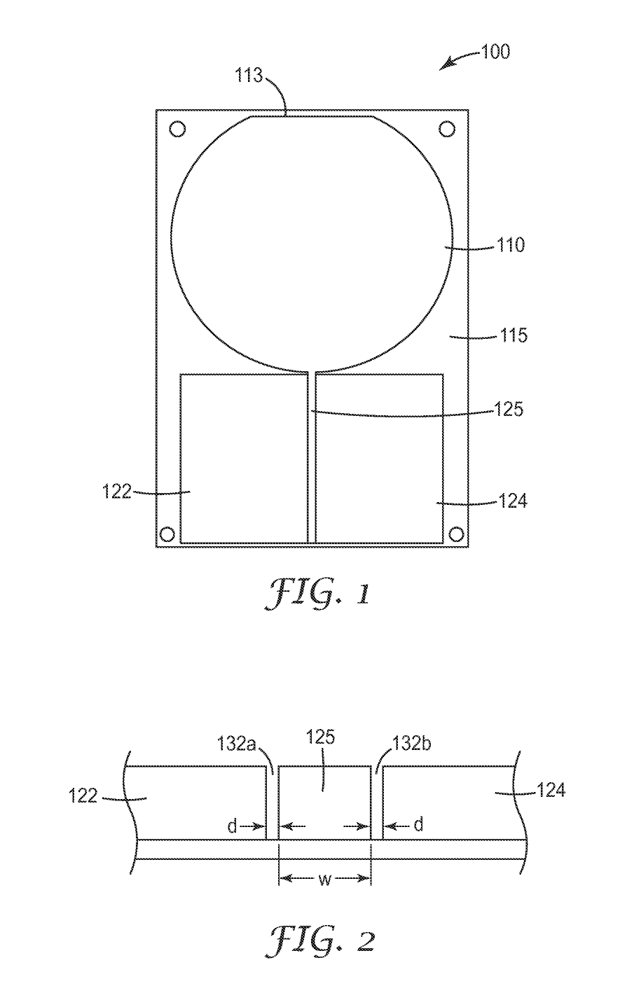

FIG. 1 shows a first aspect of the present invention, antenna 100. The antenna 100 comprises a uniplanar structure with multiple separate and contiguous metallic islands. A first portion of the antenna 100 comprises a substantially circular metallic (radiating) element 110, having a cut-off or flattened portion 113. In addition, a substantially linear or line-shaped metallic stem or strip element 125 is also provided and is connected to an edge of the substantially circular metallic element 110. Antenna 100 further includes a pair of substantially rectangular side elements 122, 124 disposed on opposite sides of the strip 125. In one aspect, the rectangular side elements 122, 124 can be of identical shape. These substantially rectangular side elements 122, 124 are electrically isolated from the substantially circular element 110 and strip 125. As a uniplanar structure, each of the metallic elements 110, 122, 124, 125, are disposed in the same plane. The antenna is adapted in impedance to a common coaxial connector impedance.

Each metallic element can be formed from a metal or other conductive material. In one aspect, the metal can comprise a metal having a high conductivity, such as copper. Other metals such as aluminum, zinc, brass, and other good conductors of electricity can be used. The metal can have a thickness of from about 0.025 mm to about 1 mm.

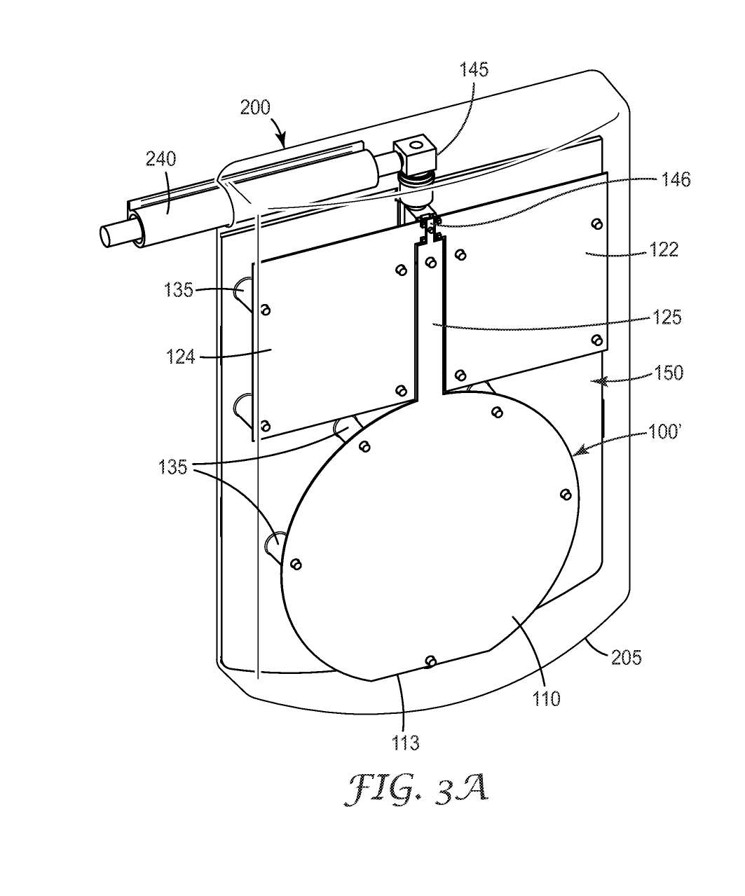

FIG. 2 shows a close-up view of the spacing between rectangular side elements 122, 124 and strip 125. The dimensions of the coplanar waveguide are d, W and h, where d is the spacing between the ground (here rectangular side wall 122 or 124) and the center conductor (here strip 125), W is the width of the center conductor (here strip 125), and h (not shown) is the thickness of the substrate.

In one aspect, antenna 100 comprises a metallic material that is etched on a dielectric substrate 115. As all the metal is disposed in the same plane, the manufacturing process and costs can be simplified. In an alternative aspect, antenna 100 can be formed by a metal stamping process. As shown in FIG. 1, antenna is low in profile, and can be easily mounted to a wall or ceiling or utility pole via an adhesive or other conventional attachment mechanism.

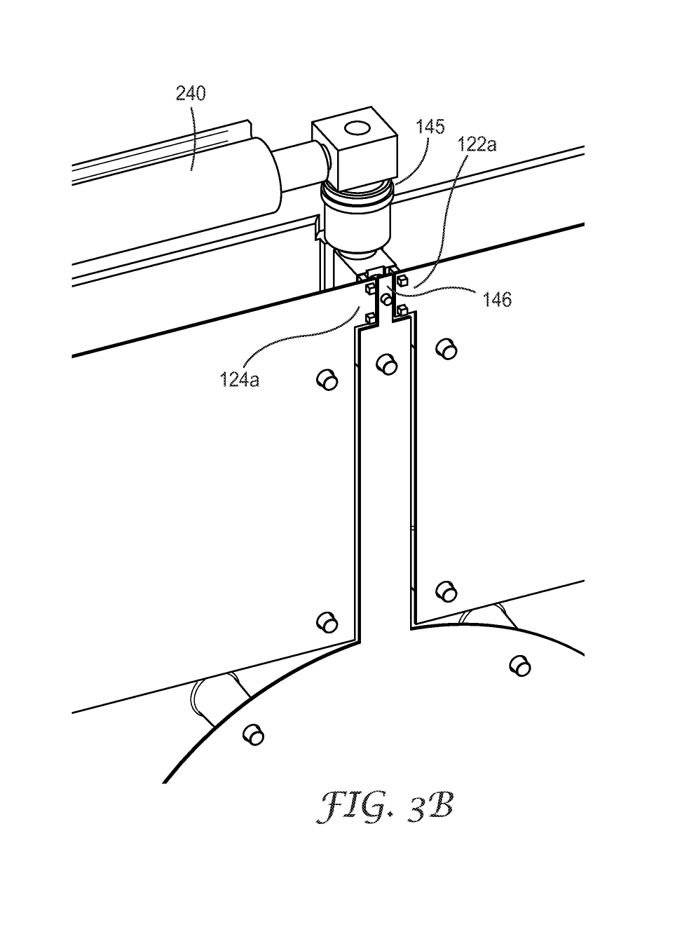

In the embodiment of FIG. 1, the substrate 115 of the antenna 100 can comprise any conventional dielectric, such FR4 or R4003. In this aspect, the substrate of the antenna can have a dielectric constant of about 4. However, low cost dielectric substrates such as FR4 can have significant loss, which is the fraction of the power supplied to the antenna not radiated and instead dissipated within the structure. To alleviate this potential loss issue, in an alternative aspect, we have developed an alternative design of FIGS. 3A, 3B where the antenna is not printed or etched on the substrate. Instead the antenna is made of stamped metal pieces that are then assembled together into the housing. In this manner, the efficiency of the antenna is improved to nearly 100%.

In some aspects, the antenna can be etched on a dielectric laminate. For example, low dielectric constant and low loss laminates such as RT/Duroid 5880 and RT/Duroid 5870 can be used to manufacture the antenna. A suitable substrate can include a material such as FR4, 4350B or 4003C. These are relatively low cost substrates that would not yield a significant degradation of performance.

The impedance of the waveguide can be determined by d, W, h, and the dielectric constant of the substrate. For a first example, for the antenna 100 of FIG. 1, the following parameter values can be utilized: h=1.6 mm, d=0.275 mm, and W=2.2 mm. In a second example, the following parameter values can be utilized: h=0.4 mm, d=0.825 mm, W=8.25 mm. In a third example, which is made of metal stamped components (see FIGS. 3A, 3B), the following parameter values can be utilized: d=0.825 mm, W=8.25 mm.

Referring to the first example above, the antenna has an impedance bandwidth range of 700 MHz to 6 GHz. This example antenna can support wireless communications operation in this frequency range. The dimensions of the first and second ground planes (e.g., side elements 122, 124) can be 44 mm in width by 61 mm in length. The substantially circular radiating element can have a radius of 44 mm. If dimensions of the ground elements are reduced, the bandwidth will be reduced; likewise reducing the radius of the substantially circular radiating element will reduce the bandwidth. The substrate thickness in this example is 1.6 mm.

In an alternative version, the second example mentioned above, the antenna has an impedance bandwidth of 400 MHz to 6 GHz. The dimensions of the ground planes (e.g., side elements 122, 124) are 109 mm by 110 mm, and the radius of the substantially circular element is 100 mm. The substrate thickness in this second example is 0.4 mm.

Antenna 100, 100′ can have a broad radio frequency (RF) bandwidth and an omni-directional radiation pattern. When implemented in a building, a group of antennas 100 can provide the same floor to floor coverage. The antenna has a linear polarization.

As mentioned above, in an alternative aspect, the antenna can be made of stamped metal pieces that are then assembled together into the housing. For example, FIG. 3A shows an antenna assembly 200 that includes a metallic antenna structure 100′ mounted in a housing 205. The antenna 100′ comprises a uniplanar structure with multiple separate and contiguous metallic islands. A first portion of the antenna 100′ comprises a substantially circular metallic element 110, having a cut-off or flattened portion 113. In addition, a substantially linear or line-shaped metallic stem or strip element 125 is also provided and is connected to an edge of the substantially circular metallic element 110. Antenna 100′ further includes a pair of substantially rectangular side elements 122, 124 disposed on opposite sides of the strip 125. In one aspect, the rectangular side elements 122, 124 can be of identical shape. These substantially rectangular side elements 122, 124 are electrically isolated from the substantially circular element 110 and strip 125. As a uniplanar structure, each of the metallic elements 110, 122, 124, 125, can be disposed in the same plane, as the metallic elements are mounted onto a support plate 150 via support spacers 135.

Antenna 100′ can be contained within a housing 205 that can be formed from a conventional material such as plastic. The housing can be adhesively mounted to a wall, ceiling or utility pole. Alternatively, housing 205 can be mounted via other conventional attachment means (e.g., screws, bolts, etc.). In one aspect, housing 205 has a low profile so that it can have satisfactory aesthetic appeal. The housing 205 can include a removable cover to provide access to the antenna 100′ and any internal connections.

In one aspect, antenna 100, 100′is designed with a 50 ohm impedance. Accordingly, the antenna may be fed by a standard commercial RF connector, such as a small miniature assembly (SMA) connector. In an alternative aspect for other antenna applications, passive intermodulation distortion may be reduced with a modified connector, such as a DIN 16 or an N-type connector.

For example, as shown in FIG. 3B, the antenna can be fed from a coaxial cable 240, that can be mounted in a building or other structure, by a coaxial coupling or connector 145. Connector 145 can comprise a QMA or an SMA connector. The center pin of connector 145 can be connected (e.g., via soldering) to a mounting pin 146 formed on an end of metallic element strip 125. In addition, the legs of connector 145 can be connected (e.g., via soldering) to mounting portions 122a, 124a of the side elements 122, 124. In this implementation, the side elements 122, 124 can act as ground islands.

In another aspect of the invention, multiple antennas can be implemented to provide polarization diversity in a multiple antenna system. Multiple Input Multiple Output antennae or MIMO antennae can be used to enhance the throughput of the received data rate of a receiving radio through antenna diversity. Antenna diversity refers to the use of multiple antennae in a wireless communications systems. To realize the benefit of MIMO, also called the diversity gain, the antenna patterns are not correlated. The received patterns of two antennas lack correlation if whenever the signal received is weak at the output of one antenna, the signal received at the output of the other antenna is stronger. In this example, deep signal extinguishment, also called signal fading, is avoided and a good signal to noise ratio can be maintained.

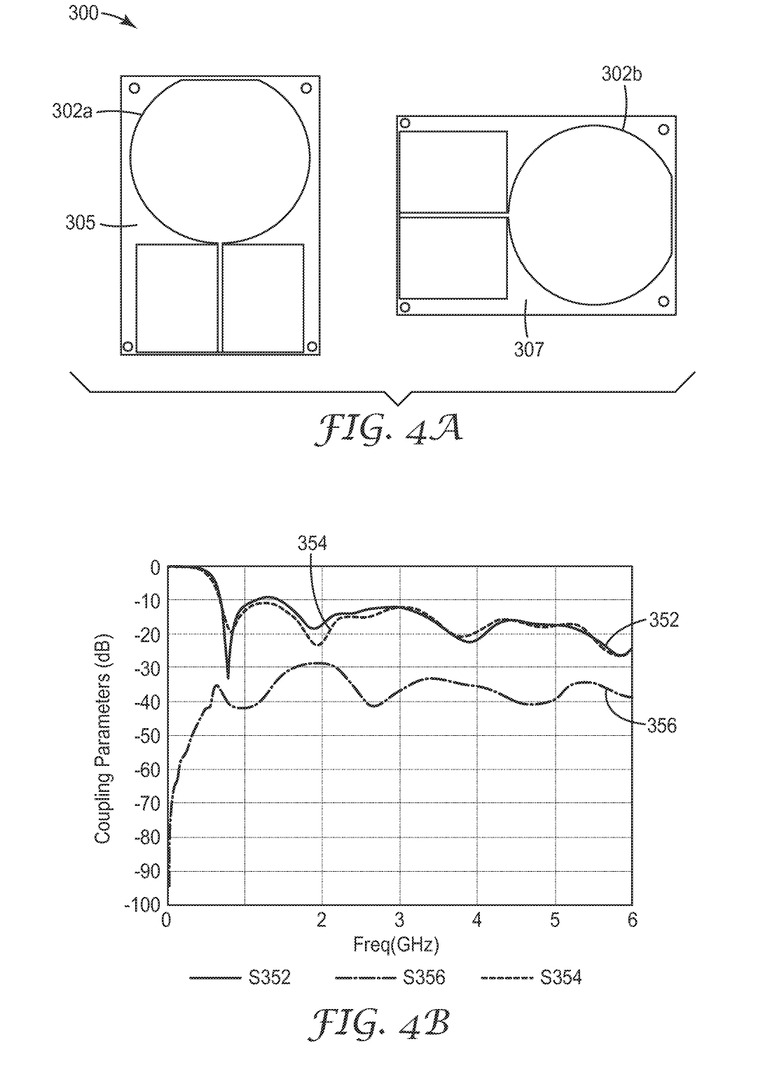

For example, FIG. 4A shows an arrangement of two antennas 302a, 302b oriented at right angles to each other, to provide a multiple input antenna. Each antenna can be configured in the same manner as antenna 100, described above. In this example, antenna 302a is mounted on a dielectric substrate 305 and antenna 302b is mounted on a dielectric substrate 307. Alternatively, the antennas 302a, 302b can each be individually configured in the same manner as antenna 100′. The antennas can be mounted in the same structure or they can be mounted in separate structures. The distance between the two antenna can be minimal, for example between 10 and 50 mm. The orientation is important in this aspect, as the antennas should be positioned at right angles to each other so that their respective axes of polarization are perpendicular. As a result, the structure creates a cross-polarized antenna. In this aspect a low pattern correlation can be achieved.

FIG. 4B shows simulated cross-coupling parameters of a two antennae MIMO implementation. Trace 352 and trace 354 show the return loss at the input of antenna 1 and antenna 2 respectively; trace 356 is the isolation coefficient. Because the isolation between the two antennas is less than −30 dB across, and the return loss is better than −10 dB, the antennae pattern correlation is essentially zero. Since the antennae pattern correlation is zero, the benefit of using a MIMO antenna is maximized.

In another aspect of the invention, the antenna structures described herein can be further modified to provide for tuned frequency coverage by use of an appropriately located and sized slot formed in the metallic element of the antenna structure. Tuning the frequency of an antenna refers to the ability to deny the reception of certain frequencies in the radio spectrum. In this aspect, a slot embedded in the radiating element can be used as a notch filter to reject one or multiple frequencies of interest. A single slot can be used to notch a single frequency, and multiple slots can be used to notch multiple frequencies.

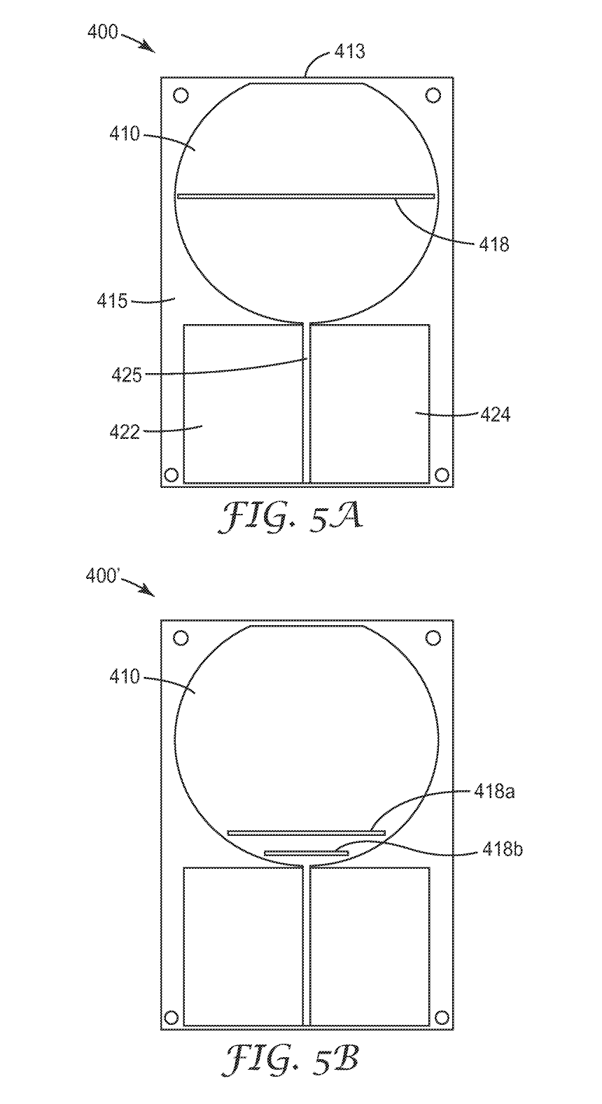

For example, FIG. 5A is a front view of an antenna 400, which is configured similar to antenna 100 described above, except that the substantially circular metallic element 410 includes a slot 418. As with antenna 100, antenna 400 comprises a uniplanar structure with multiple separate and contiguous metallic islands. A first portion of the antenna 400 comprises a substantially circular metallic element 410, having a cut-off or flattened portion 413. In addition, a substantially linear or line-shaped metallic stem or strip element 425 is also provided and is connected to an edge of the substantially circular metallic element 410. Antenna 400 further includes a pair of substantially rectangular side elements 422, 424 disposed on opposite sides of the strip 425. In one aspect, the rectangular side elements 422, 424 can be of identical shape. These substantially rectangular side elements 422, 424 are electrically isolated from the substantially circular element 410 and strip 425. As a uniplanar structure, each of the metallic elements 410, 422, 424, 425, can be disposed in the same plane on dielectric substrate 415. Alternatively, in another aspect, antenna 400 can be suspended in air, similar to antenna 100′.

In addition, as shown in FIG. 5A, antenna 400 includes a metal incision or a slot 418. In this example, the slot 418 can be 2 mm×94 mm in size and is positioned at the center of the radiating element 410. The opposite lateral ends of slot 418 extend close to the edge, e.g., about to within 3 mm of the edge, of substantially circular element 410. With the slot as described in this example, the antenna will reject a 1.2 GHz frequency. Depending on the application, the slot can further be moved up and down (in the orientation of FIG. 5A) to tune the frequency which is rejected.

In another aspect, FIG. 5B shows an antenna 400′ that includes multiple slots formed in the substantially circular element 410. The slots can be positioned close to each other, or close to the top or bottom of the substantially circular element 410. In this example, two slots 418a and 418b are positioned in the substantially circular element 410 so that two frequencies bands (1.75 GHz and 2.65 GHz) are notched out. The relative locations of the slots can be changed to tune out other frequency bands, as would be apparent to one of ordinary skill in the art given the present description.

### Experiment

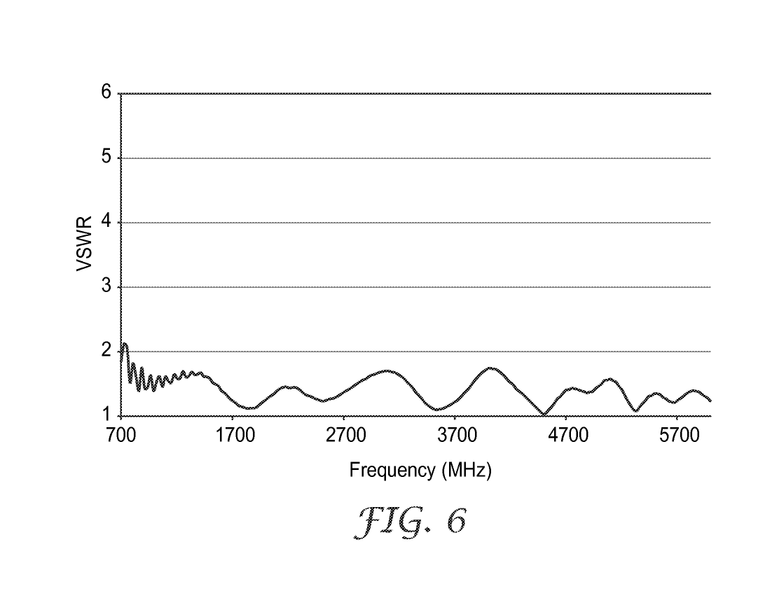

A first sample antenna having a configuration as described above with respect to antenna 100 of FIG. 1 was constructed. A VSWR (voltage standing wave ratio) measurement of the sample is shown in FIG. 6. This measurement demonstrates better than 2:1 VSWR over a wide frequency range 700 MHz to 6 MHz.

As is understood, it is desirable to achieve an antenna voltage standing wave ratio of better than or as close as possible to 2:1, which signifies that the antenna achieved a good return loss.

The antenna of the present invention provides a number of advantages. Antenna 100, 100′ have broadband response and can thus be used with a great number of RF technologies. The antenna 400, 400′ can be utilized to tune out certain frequencies. With a 50 ohm impedance, the antennas described herein do not require a balun. The antennas can be implemented in one or more low profile housings with aesthetic appeal as part of an IBW or hybrid network.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. An antenna, comprising:
a uniplanar structure having a plurality of separate and contiguous metallic elements, wherein a first element comprises a substantially circular metallic element having a flattened portion, a second element comprises a substantially linear metallic strip connected to an edge of the first element, and a pair of substantially rectangular side elements disposed on opposite sides of the second element that are electrically isolated from the first and second elements.

2. The antenna of claim 1, wherein the pair of substantially rectangular side elements are of identical shape.

3. The antenna of claim 1 having a bandwidth extending from about 400 MHz to about 6 GHz.

4. The antenna of claim 1, further comprising a connector coupling that includes a coaxial receptacle having a main body mounting portion mountable to the side elements and a center pin configured to connect to the second element.

5. The antenna of claim 1, wherein the antenna has an impedance of 50 ohms.

6. The antenna of claim 1, wherein the plurality of separate and contiguous metallic elements are disposed on a dielectric substrate.

7. The antenna of claim 1, further including a housing to having a low profile cover.

8. The antenna of claim 7, wherein one side of the housing further includes an adhesive backing for mounting.

9. The antenna of claim 1, wherein each of the antenna elements are mounted onto a support plate via support spacers such that the antenna elements are disposed in the same plane.

10. The antenna of claim 1, wherein the first element further includes a first slot formed therein.

11. The antenna of claim 10, wherein the first element includes a second slot formed therein, wherein the first slot tunes out a first frequency and the second slot tunes out a second frequency different from the first frequency.

12. The antenna of claim 1, wherein the antenna does not include a balun.

13. The antenna of claim 1, further comprising a second antenna and a housing to house both antennas in an orthogonal orientation.
